(19) United States
(12) Patent Application Publication
(10) Pub. No.: US 2025/0205988 A1
(43) Pub. Date: Jun. 26, 2025

(54) PRODUCTION METHOD AND PRODUCTION SYSTEM FOR FIBER BASED CELLULOSE MATERIAL PRODUCTS

(71) Applicant: Blue Ocean Closures AB, Karlstad (SE)

(72) Inventor: Lars Sandberg, Hammarö (SE)

(73) Assignee: Blue Ocean Closures AB, Karlstad (SE)

(21) Appl. No.: 18/849,186

(22) PCT Filed: Mar. 21, 2023
(86) PCT No.: PCT/EP2023/057151

§ 371 Date: Sep. 20, 2024

(30) Foreign Application Priority Data
Mar. 21, 2022 (SE) 2250348-6

(51) Int. Cl. B31B 50/74; B31B 50/00; B31B 50/04; B31B 50/10; B31B 50/59; B31B 100/00

(52) U.S. Cl. CPC B31B 50/741; B31B 50/006; B31B 50/04; B31B 50/10; B31B 50/747; B31B 50/59; B31B 2100/00

(57) ABSTRACT

This invention relates to Production method for fiber based cellulose material products by means of converting a blank or web, wherein there is provided a production space (1) including a converting production unit (2) intermittently producing a shaped product (5B), a supply station (3) and a supply path (4), comprising the steps of: a. Providing a supply of unconverted blanks or a web (5) at said supply station (3) having a density below 0,5 kg/dm³ and a wet content below 20% weight. b. Feeding an unconverted portion (5A) of said unconverted blanks or a web along said supply path (4), c. Converting said unconverted portion (5A) by means of said converting production unit (2) to a converted product (5B), Wherein also the following further steps are performed:—Providing humidity sensor/s (6) measuring the humidity within said production space (1),—Controllably feeding said unconverted portion (5A) along said supply path (4) to provide a time span (T) during feeding from said supply station (3) to said converting production unit (2), wherein said time span (T) provides for sufficient time of exposure of said unconverted portion (5A) to the environment in said production space (1) to obtain a moisture profile (Δθ) within a preset moisture content (θ₁-θ₂).

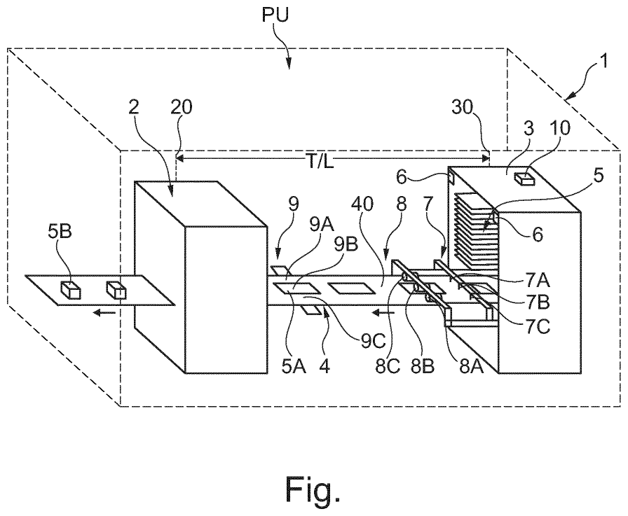

### TECHNICAL FIELD

This invention relates to a production method and system for fiber based cellulose material products by means of converting blanks or portions of web, into shaped products, wherein there is provided a production space including an intermittently converting production unit, a supply station and a supply path.

### BACKGROUND

Natural materials and fiber based cellulose materials in specific are sensitive for moisture content when being converted. This includes creasing (when materials are locally delaminated to introduce folds), cutting (when materials and fibers are cut or separated), and press-forming (when materials are reshaped with or without delamination or fusing of fibers into new bonds and structures). The moisture content is extra important if fiber bonds are broken or if new bonds is to be formed in the operation.

If too much water is introduced in or with the material and are needed to be dried away in or after the converting process, this leads to excessive need of heat or energy. Optimizing the moisture content therefor helps optimizing not only the quality of the product but also the energy consumption. It is to be understood that the invention does not relate to the continuous production of paper and board, wherein there is continuous feeding of a web from a wet end to a roll-up end, resulting in a product in the form of a roll including numerous layers of paper/board. Instead the invention relates to production of intermittently produced objects.

In a typical operation flat material are fed from as sheets, pre-cut shapes or from a roll before the actual operation. In some operations for example in sheet cutting or dry-forming the material might be manufactured direct before the converting operation. The moisture content in the material in the moment of converting typically depends on the initial moisture content, the surrounding atmosphere and the time exposed to the later. The initial moisture content depends on the manufacturing conditions but also on the storage conditions, storage time, packing and the climate under which the material has been stored and transported. It is not uncommon that the moisture content varies over the width of the material or from start to end of a batch (e.g., pallet of sheets or a roll). In one example the moisture content on the top and sides of a roll can be dry from the outside air, the mid part more moist as from production and the part closes to the core dryer again.

### SUMMARY OF THE INVENTION

This innovation relates to a system for controlled conditioning of the natural materials before converting, in accordance with claim 1, preferably by means of an integrated feed back loop based on one or several data sets and/or sensors.

Thanks to the invention a high level of quality of the converted products may be safeguarded.

In a preferred embodiment an active part is provided that may supply a controlled amount of fluid to desired parts of a blank, prior to converting. Such an active part may be in the form of a system including a plurality of spraying nozzles positioned spread out over the width of the supply path, wherein means are provided to regulate the amount of fluid sprayed. Preferably the nozzles are individually controlled, whereby parameters can be controlled variably across the web separately. Preferably the feedback loop collects data from the movement of the web or blanks allowing a constant flow per distance even for intermittent movements with varying speed. In addition to the movement of the web/blanks the following parameters and data sets are examples of control input, that may be used alone or in any combination in an integrated feedback loop to control and optimize the time span and/or moisture adding and/or moisture decreasing activities in the supply path:
1. Data set with original produced moisture content of ingoing material (M spec)
2. Data set with production date (M date)
3. Data set with measured moisture content of roll material (M meas)
4. Data set of outside relative humidity outside (RH out)
5. Measured data from surrounding relative humidity in the production facility (RH in)
6. Measured moisture content in the web going into the process (M web)
7. Measured total basis weight of the material going in (W web1)
8. Measured total basis weight of the material after moisture adding nozzles (W web2)
9. Function of (the derivate) of the tool temperature (drop) indicating drying in pressing tool (T tool)
10. Measured moisture content of converted products or scraps obtained from the converting operation.

Accordingly, the feedback loop can be built up by direct measurements or data sets in combination but can also include more advanced calculated entities such as the example in point 9 above, wherein the indication of the moisture content is calculated from the cooling effect of evaporating water in the heat supplying converting step. Typically, a heated tool is somewhat cooled from the heat energy needed to transfer water from liquid state or a state bound to the natural material into steam. This cooling, when measured, can give an indication of both the amount of water evaporated but also how the water is removed. The later can be used to optimize the moisture content in the material in order to avoid a convert having too dry material or too much water in the process that can cause problems, e.g. steam explosions that delaminate or in other ways damage the material or converted product.

In one application of the invention the fluid (e.g. mainly water) that may be added to the process can be used to condition the material also in other ways. This might include but are not limited to: adjusting pH, adding coloring pigments, adding strength additives or additives increasing recyclability, adding barrier or barrier primer additives that may provide desired properties to the converted product. Further adding fluid may also relate to adding lubricants, release agents, surfactants or other substances increasing the efficiency of the converting process.

In some applications of this invention the material may need to be dried before converting. This could be the case if the starting material (B.) has a higher than optimal moisture content or if more than optimal water is added in a spraying operation (A.). The later might be to, for example be to add a given amount of additives demanding a higher amount of sprayed water. Drying can also, as it is an easier to control method, be used to fine tune the moisture content of the ingoing material over the web or locally. A number of drying methods (e.) can be used including direct heating, radiation or hot air drying where radiation, for example drying trough IR or microvalves could be considered the most exact and easy to control methods. One additional technical advantage with the method is that added water/fluid in the form of spray/mist may reduce dusting trough binding loose fibers on the surface of the natural material. This effect can be aided trough dust control additives, or binders, added to the added fluid.

In one application, in order to aid the amount of water added or to more accurate add additives in the material, spraying can be done from opposite directions onto both sides of the web or blanks.

In one application the addition of moisture can be done by means of steam and/or aerosols and/or micronized droplets in order to aid and speed up the absorption of moisture into the natural material. Another alternative could be to distribute the water more evenly throughout a porous material.

In one application the moisture content of web or blanks could be controlled to vary over the surface of the intended product. This could be done by means of only add moisture on areas that are going to be converted but could also be used to optimize the converting effect locally, by means of having varied addition of moisture/fluid to different sub-areas of the surface of the intended product. Technical reasons to do this might be that some sub-areas might need higher moisture content to add forming or flexibility while other sub-areas of the intended product might benefit from a lower moisture content in order to aid cutting or minimize shrinkage in the product after forming. The local variation of moisture content after spraying or drying can be aided by masking in order to increase the definition of the moisture profile.

In one application the addition of water can be done through a stamping or printing operation. This might add the speed of the adsorption of water through the application releasing of pressure obtained by a stamp or a roll but can also be used to aid the definition of the positioning of the water added. Digital water-based printing methods, or concept derived from such methods, lends it specifically well as it includes option to control the added water content both over the surface and from product to product.

In the enclosed Figure there is outlined an exemplary embodiment of a production system according to the invention, presenting some basic principles of the invention and also some preferred aspects.

### DETAILED DESCRIPTION

In the figure, which is schematic, there is shown a production unit PU for fiber based cellulose material products by means of converting a blank or web. The production unit PU is provided within a production space 1, wherein the environment within said production space 1 is being controlled, e.g. by (at least partly) sealing the production space 1 from the surrounding environment and control inlet and outlet of air to/from the production space 1. Alternatively, the production space 1 may be openly arranged within a building without any substantial sealing, and then use more of direct individual control of each blank/web portion 5A to be converted.

Within said production space 1 there are a converting production unit 2, a supply station 3 and a supply path 4. The converting production unit 2, is of a kind that intermittently converts a blank or web portion 5A into a shaped product. Preferably the production unit 2 includes a dry-forming press, wherein at high temperature (above 150° C.) and high pressure (above 100 bar) converting is used. At said supply station 3 there is provided a supply of unconverted blanks or a web 5, having a density below 0,5 kg/dm³ and a wet content below 20% weight. In the figure merely, the example of having a supply 3 of blanks 5 is shown. However, the skilled person may foresee that the basics in the following may also relate to a supply 3 of a web, e.g. on roll. (not shown).

It is shown that from the supply station 3 an unconverted portion 5A of a blank is fed along the supply path 4. At the converting production unit 2 the unconverted portion 5A is converted to a converted product 5B, which in the exemplary shown production unit 2, operates intermittently and by means of pressing shapes the unconverted portion 5A into a shaped product 5B, preferably including some kind of cup-shape.

Further it is shown that the production unit PU includes a control unit 10 and may be provided with one humidity sensor 6, preferably a plurality of humidity sensors 6, enabling measuring of the humidity RHi within said production space 1, wherein humidity measurements are supplied to the control unit 10, such that the unconverted portion 5A controllably may be fed along said supply path 4 during a time span T of feeding from said supply station 3 to said converting production unit 2, providing for sufficient time of exposure of said unconverted portion 5A to the environment in said production space 1 to obtain a moisture profile 40 within a preset moisture content range θ₁-θ₂. Preferably the humidity RHi in said production space 1 is controlled to be within the range of 25%<RHi<75%, preferably 30%<RHi<70%.

Further, it is shown that the production unit PU may be provided with a fluid supply unit 7, e.g. adjacent said supply path 4, preferably above said supply path 4. Most preferred there is provided a plurality of fluid supply members 7A, 7B, 7C that preferably are individually controlled, arranged to provide controlled laterally and/or longitudinally distributed moisture to said unconverted portion 5A.

Further, it is shown that the production unit PU may be provided with a heat supply unit 8 adjacent said supply path 4, e.g. by means of IR radiation from above. Most preferred there is provided a plurality of heat supply members 8A, 8B, 8C that preferably are individually controlled, arranged to provide controlled laterally and/or longitudinally distributed heat supply to said unconverted portion 5A.

Further, it is shown that the production unit PU may be provided with a at least one weight measuring unit 9 adjacent said supply path 4. More preferred there is provided a plurality of individual weight measuring members 9A, 9B, 9C arranged to individually measure laterally distributed weight of said unconverted portion 5A. Most preferred there may be arranged at least two weight measuring units 9, 9′ units distributed longitudinally along said path 4.

In a preferred embodiment the timespan T, time of exposure of said unconverted portion 5A along the supply path 4, is at least 10 s, preferably at least 20 s. As exemplified in the figure the timespan T is the time it will take for a web portion or a blank 5A to travel from a first point 30 of first total exposure to the environment within the production space 2 to a second point 20 immediately before being converted.

Furthermore, preferably the moisture profile Δθ of said unconverted portion 5A is such that it deviates within a range of maximum +−1% (preferably of maximum +−0,5%) in relation to a set desired reference value θᵣ, wherein accordingly a sub-area of said unconverted portion 5A with a lowest moisture content θ1 is maximum 1% below the reference value θᵣ, and a sub-area of said unconverted portion 5A with a highest moisture content θ1 is maximum 1% above the reference value. Further, preferably said maximum deviation is maintained for at least 30 minutes, more preferred at least one hour. More preferred said moisture reference value θᵣ, is such that the moisture content is larger than 4% and less than 20%, preferably 7-15%.

1. Production method for fiber based cellulose material products by means of intermittently converting a blank or a portion of a web, wherein there is provided a production space including a converting production unit intermittently producing a shaped product, a supply station and a supply path, comprising the steps of:
providing a supply of unconverted blanks or a web at said supply station having a density below 0,5 kg/dm3 and a wet content below 20% weight,
feeding an unconverted portion of said unconverted blanks or said web along said supply path,
converting said unconverted portion (5 A) by means of said intermittently converting production unit to a converted shaped product,
providing humidity sensor/s measuring the humidity (RHi) within said production space, feeding measurements regarding humidity (RHi) to a control unit,
controllably feeding said unconverted portion along said supply path to provide a time span during feeding from said supply station to said converting production unit, wherein said time span provides for sufficient time of exposure of said unconverted portion to the environment in said production space to obtain a moisture profile within a preset moisture content of said unconverted portion.

2. Production method according to claim 1, wherein there is provided a fluid supply unit within said supply path.

3. Production method according to claim 2, wherein said fluid supply unit includes a plurality of fluid supply members that are individually controlled arranged to provide controlled laterally and/or longitudinally distributed fluid supply to said unconverted portion.

4. Production method according to claim 1, wherein there is provided a heat supply unit within said supply path.

5. Production method according to claim 4, wherein said heat supply unit includes a plurality of heat supply members that preferably are individually controlled, arranged to provide controlled laterally and/or longitudinally distributed heat supply to said unconverted portion.

6. Production method according to claim 1, wherein there is provided at least one weight measuring unit within said supply path.

7. Production method according to claim 6, wherein said weight measuring unit includes a plurality of individual weight measuring members—arranged to individually measure laterally distributed weight of said unconverted portion.

8. Production method according to claim 6, wherein there is provided at least two weight measuring units units distributed longitudinally along said path.

9. Production method according to claim 1, wherein said timespan is at least 10 s, preferably 20 s<T<10 min.

10. Production method according to claim 1, wherein said density is between 0.1 to 0,4 kg/dm3.

11. Production method according to claim 1, wherein said moisture profile of said unconverted portion is such that it deviates within a range of maximum +−1%.

12. Production method according to claim 1, wherein said humidity (RHi) is such that the moisture content of said unconverted portion is larger than 4% and is less than 20%, wherein said humidity (RHi) is controlled to be within the range of 25%<RHi<75%.

13. Production system for producing fiber based cellulose material products by means of intermittently converting a blank or portion of a web, comprising a production space including an intermittently converting production unit—, a supply station—, a supply path,—and a control unit, wherein said supply path has a length and is arranged with a feeding device arranged to feed said unconverted portions from said supply station to said production unit, wherein said production space includes at least one humidity sensor within said production space feeding measurements regarding humidity (RHI) to said control unit and said control unit is arranged to controllably feed said unconverted portions along said supply path to said converting production unit to provide sufficient time of exposure of said unconverted portion to the environment in said production space to obtain a desired moisture profile.

14. A production system, according to claim 13, wherein along said supply path there is arranged at least one moisture-adding and/or moisture-decreasing device to be used alone or in any combination in an integrated feedback loop with said control unit to optimize said moisture profile.

15. A production system, according to claim 13, wherein along said supply path there is arranged at least one weight measuring unit to be used alone or in any combination in an integrated feedback loop with said control unit to optimize said moisture profile.

16. Production method according to claim 1, wherein said moisture profile of said unconverted portion is such that it deviates within a range of maximum +−0,5%.

17. Production method according to claim 1, wherein said moisture profile of said unconverted portion is such that a maximum deviation is maintained for at least 30 minutes.

18. Production method according to claim 17, wherein the maximum deviation is maintained for at least one hour.

19. Production method according to claim 1, wherein said humidity (RHi) is such that the moisture content of said unconverted portion is larger than 4% and is between 7-15%, wherein said humidity (RHi) is controlled to be within the range of 25%<RHi<75%.

20. Production method according to claim 1, wherein said humidity (RHi) is such that the moisture content of said unconverted portion is larger than 4% and is less than 20%, wherein said humidity (RHi) is controlled to be within the range of 30%<RHi<70%.
